(19) United States
(12) Patent Application Publication
(10) Pub. No.: US 2017/0345410 A1
(43) Pub. Date: Nov. 30, 2017

(54) TEXT TO SPEECH SYSTEM WITH REAL-TIME AMENDMENT CAPABILITY

(71) Applicant: Tyler Murray Smith, Runnells, IA (US)

(72) Inventor: Tyler Murray Smith, Runnells, IA (US)

(21) Appl. No.: 15/606,819

(22) Filed: May 26, 2017

Related U.S. Application Data
(60) Provisional application No. 62/341,773, filed on May 26, 2016.

(51) Int. Cl. G10L 13/02; H04L 29/08; G06F 17/21

(52) U.S. Cl. CPC G10L 13/02; G06F 17/218; H04L 67/2823

(57) ABSTRACT

An application configured to be a text-to-speech (“TTS”) application wherein the application is capable of reading a document aloud to a reviewer via a device, such as a smartphone, an mp3 device, or a tablet, while the reviewer is able to make amendments to the document in real-time is presented.

### CROSS-REFERENCE TO RELATED APPLICATIONS

The present application claims priority to U.S. Provisional Patent Application No. 62/341,773 which was filed on May 26, 2016, which is hereby incorporated by reference herein in its entirety, including any figures, tables, or drawings.

### FIELD OF THE DISCLOSURE

The present disclosure relates to the field of text to speech systems, with the capability of amending text through speech commands.

### BACKGROUND OF THE DISCLOSURE

Many document reader applications (“apps”) are supported by text-to-speech (“TTS”) and have a highlight function. The problem with these apps is the process requires the following steps to mark or highlight an important passage or section: i) the reviewer must stop the TTS from reading the text, ii) the reviewer then must look at a screen or display of the recently reviewed text, which means that the reviewer must be sitting in front of a computer or have another display with then that they can review, iii) the reviewer then must move the cursor, using a mouse or a touch screen, to the beginning of the text where they want the highlighting to begin, iv) the reviewer then must move the cursor, using a mouse or a touch screen, to the end of the area to be highlighted, v) once the desired text is selected, the reviewer must then select the highlight button, using a mouse or touch screen or the like, which highlights the desired text, and vi) the reviewer then must select a play button again to resume TTS.

This process makes document review with TTS hands-on, tedious, and fraught with interruptions. In addition, this process requires the reviewer to visually review a screen with the text thereon, which means the reviewer must be sitting in front of a computer or have another device with a display. Because this process requires the reviewer to visually review a screen, while simultaneously operating a mouse or other control device (such as a touch screen) this essentially eliminates the possibility of reviewing text while driving or performing any other operation that requires the reviewer's visual attention. Furthermore, this process is incredibly time consuming and inefficient.

There have been several attempts in the art to bring about a text-to-speech system which permits verbal editing of a document that is being read. For example, US 20050177369 discloses a text-to-speech conversion process having a text-to-speech engine that converts the input text into a processed text form, which includes speech features. A visual editing interface displaying the processed text form using graphical indicators on an output device to allow a reviewer to edit the text and graphical indicators to modify the speech features of the text input. This has the drawback of requiring an output device.

US 20050021343 describes a method and apparatus for activating an object for highlighting during a presentation which includes recognizing a spoken activation word. An activation link is invoked when the activation word is recognized, and includes an activation action taken. The presentation is prepared by designating a portion for highlighting by association with the activation link, and the activation word. The activation action includes substitution of the designated portion with another object, activating a multimedia object, changing a background color, applying a graphic effect, or the like to the designated portion. However, the use of an activation word limits the application, and the edits are limited to the appearance rather than the substance.

Similarly, CA 2377405 provides a viewer for displaying an electronic book having various text-to-speech and speech recognition features. The viewer permits a reviewer to select text in a displayed electronic book and have it converted into corresponding speech. In addition, a reviewer may have the viewer automatically perform text-to-speech conversion for an entire displayed electronic book or a particular page of the electronic book. The viewer also permits a reviewer to enter voice commands; however these voice commands are for navigation rather than editing.

Another form of prior art includes the Voice Dream Reader App which features 36 built-in voices that come with the app free of charge and another 146 available as in-app purchases. Voice reading allows a reviewer to listen to documents as if they were music files, allowing the file to play and be controlled as a music file would be. The app will continue reading on the lock screen, but is chiefly for reading text rather than editing.

NaturallySpeaking is another form of prior art which provides software wherein a reviewer can stop reading back in the NaturallySpeaking window by pressing the Escape (“Esc”) key. If a reviewer hears an error during read-back, the reviewer first stops the read-back, and then selects the erroneous text using a mouse, keyboard, or a verbal command. With text selected, the Correction Menu Box is launched, and the reviewer may correct the text by clicking the correction button, or saying, “Correct That”.

Based on the foregoing, there is a need in the art for a system that permits text-to-speech conversion of a document so the document may be read aloud, that improves upon the state of the art. As such, one objective of the disclosed system is to provide a system that improves the efficiency of highlighting areas of interest in text documents that are read aloud using a TTS. Another objective of the disclosed system is to provide a system that makes it easier to highlight areas of interest in text documents that are read aloud using a TTS. Another objective of the disclosed system is to provide a system that allows documents to be reviewed and areas of interest in the text to be highlighted while the reviewer is driving or otherwise performing other operations that require their visual attention.

In one example/arrangement, the system presented herein utilizes text-to-speech technology with a new process that enables listeners to mark up the text (i.e., highlight, underline, flag, etc.) with either voice or touch commands of a remote control device in real time as the text is being read. However, it is to be understood that the functionality of the remote control device may be incorporated within the TTS app itself and therefore that the remote control device is optional.

In this one exemplary arrangement, the process is as follows:
1. The reviewer uploads a text document to the application.
2. The reviewer hits “play” button and application reads text to reviewer.
3. When the reviewer hears text they want to highlight, the reviewer touches a “highlight” button or gives “highlight” voice command, and the text that was just read is highlighted (or otherwise flagged) by the application.

The application includes settings that allows the user to adjust which text, or how much, is highlighted by the command: i.e., highlight the current sentence or paragraph being read, the previous sentence or paragraph read, the previous number of seconds of text that was read, or flag the entire page(s) where the text was just read from. The application also exports to the user a report of the highlighted text and pages, as well as the time the user spent listening to the document, a feature that is useful for persons who bill by the hour.

The Problem Solved:

This is a significant improvement over the existing text-to-speech readers which has a highly interruptive and cumbersome process for listening to and highlighting text. In prior art systems:
1. Reviewer uploads a document to the application.

2. Reviewer hits “play” button and application reads text to reviewer.
3. When the reviewer hears text s/he wants to highlight, the user
   3.1 Reviewer touches the “pause” button to stop the reader;
   3.2 Moves the cursor to the beginning of the text s/he wants highlighted;
   3.3 Drags the cursor to the end of the text s/he wants highlighted;
   3.4 Touches the highlight button (this sometimes occurs as step 3.1 instead of step 3.4);
   3.5 Moves the cursor back to where the text-to-speech reader left off; and
   3.6 Touches the play button.

The system presented improves significantly upon the existing processes and technology by (1) eliminating 5 (or 6) of the 6 steps above to highlight important text as it is being read, and (2) allows the reviewer to listen to and highlight text without touching or seeing the application so it can be used in the car or on the go. Both of these improvements dramatically increasing the efficiency and usability of the text-to-speech reader for purposes of document review and study.

These and other objects, features and objectives will become apparent from the specification, claims and drawings.

### SUMMARY OF THE DISCLOSURE

A text-to-speech (“TTS”) application system wherein the system is capable of reading a document aloud to a reviewer via a device, such as a smartphone, an mp3 device, or a tablet, while facilitating the reviewer to make highlights to the document in real-time. In one configuration, the system allows the reviewer to highlight an area of interest by pressing a button or issuing a voice command contemporaneous with the text being read. When this highlight button is pressed, a predetermined amount of text is highlighted, such as the prior fifty words, or the prior ten seconds of text, as examples. This eliminates the need for the reviewer to put their eyes on the text itself, and this also eliminates the need for the text to be displayed to the reviewer. The system also is configured to provide a report of the highlighted text.

### BRIEF DESCRIPTION OF THE DRAWINGS

For a more complete understanding of the present disclosure, the objects and advantages thereof, reference is now made to the ensuing descriptions taken in connection with the accompanying drawings briefly described as follows.

FIG. 1 is a flowchart showing the text-to-speech system, according to an embodiment of the present disclosure; and

FIG. 2 is a plan view of the key fob controller for the disclosure, according to an embodiment.

### DETAILED DESCRIPTION OF THE DISCLOSURE

In the following detailed description, reference is made to the accompanying drawings which form a part thereof, and in which is shown by way of illustration of specific embodiments in which the disclosure may be practiced. These embodiments are described in sufficient detail to enable those skilled in the art to practice the disclosure, and it is to be understood that other embodiments may be utilized and that mechanical, procedural, and other changes may be made without departing from the spirit and scope of the disclosure(s). The following detailed description is, therefore, not to be taken in a limiting sense, and the scope of the disclosure(s) is defined only by the appended claims, along with the full scope of equivalents to which such claims are entitled.

Notably, while the term “highlight” or “highlighting” is used herein this term is to be construed broadly and is intended to mean selection of text. This highlighting may include changing the color of the text and/or the background color surrounding the text, however changing the color or adding color or highlighting, as it is known, is not required. Instead, the term highlighting is to be construed broadly as indicating text of interest to the reviewer.

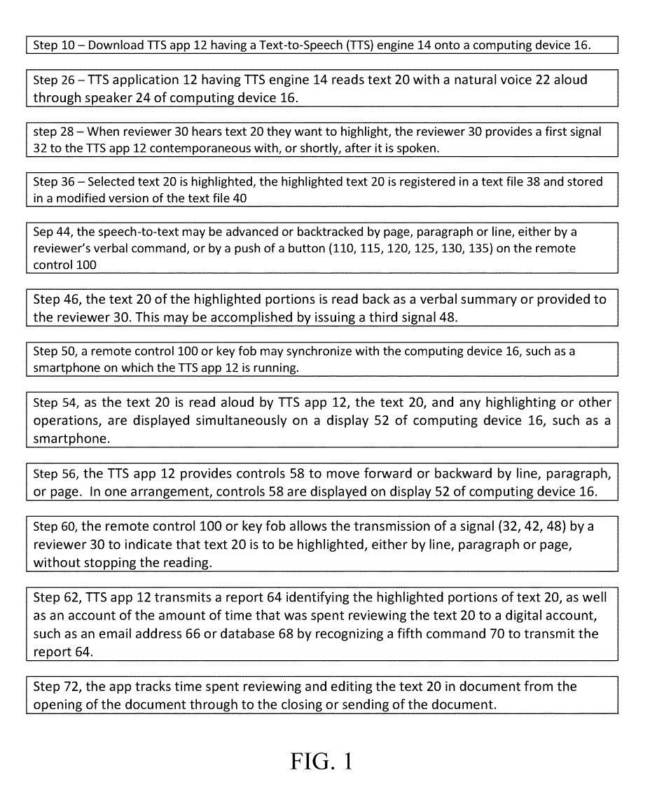

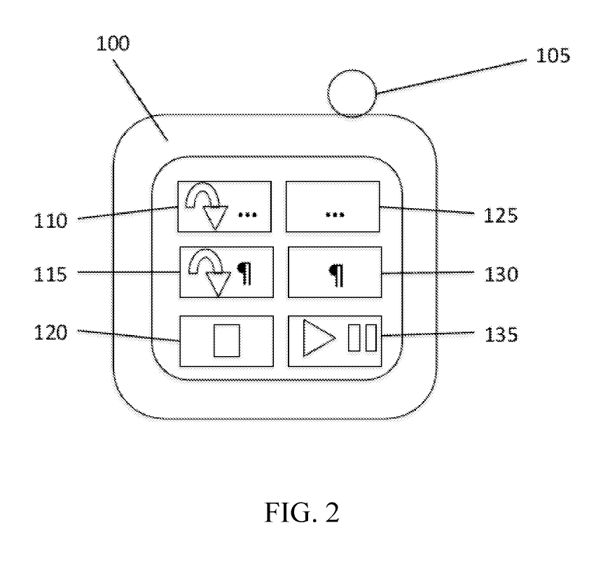

As one example, embodiments of the disclosure and their advantages may be understood by referring to FIGS. 1-2, wherein like reference numerals refer to like elements.

The system, in an embodiment of an app, such as an application, software, code or the like, running on a computing device such as a smartphone, computer, laptop, smart watch, or the like, allows the reviewer to highlight, underline or otherwise flag one or more of: (a) the current sentence or sentences or paragraph or paragraphs (question and answer in a deposition, for example), (b) the previous sentence or sentences or paragraph paragraphs (question and answer in a deposition, for example), or (c) the entire page, or (d) the entire paragraph, or (e) a predetermined number of words before and/or a predetermined number of words after initiation of the highlighting (such as 100 words before and 25 words after, for example), or (f) a predetermined amount of time before and/or a predetermined amount of time and/or after initiation of the highlighting (such as ten seconds before and five seconds after, for example), without ever stopping the TTS.

As the TTS reads the text to the reviewer, when the reviewer hears an area of interest, such as an important portion of a deposition, the reviewer initiates a signal to be provided to the app to commence highlighting the area of interest. This signal may be a button press on a remote control device, a button press on a touch screen, a voice command, or any other signal. In one arrangement, once the signal is transmitted to the app, a predetermined amount of text is highlighted, such as a predetermined number of sentences before and/or after transmission of the signal, a predetermined amount of words before and/or after transmission of the signal, a predetermined amount of time before and/or after transmission of the signal, or any other amount of text. In an alternative arrangement, after the initial signal is transmitted, the amount of text that is highlighted is affected by a second signal that is provided by the reviewer. This second signal may be a similar or identical signal as the first signal and may be a button press on a remote control device, a button press on a touch screen, a voice command, or any other signal. In one arrangement, once the second signal is transmitted to the app, a predetermined amount of text is highlighted, such as a predetermined number of sentences before and/or after transmission of the first signal and second signal, a predetermined amount of words before and/or after transmission of the first signal and second signal, a predetermined amount of time before and/or after transmission of the first signal and second signal, or any other amount of text. A such, the use of a second signal allows the reviewer to have greater amount of control over the amount of text that is highlighted. Alternatively, the second signal indicates when the highlighting is to be stopped and the application highlights the text between the first signal and the second signal. This process may be perceived as “On-the-Go Highlighting”.

In one arrangement, there is also an audible background feedback noise, slightly quieter than the TTS voice, to indicate successful highlighting while the text is being highlighted. In one embodiment, a chime sound indicates the start of the highlighting, and another chime sound indicates the end of the highlighting. The highlighting may involve changing the color or background of the text, underlining, italicizing, flagging, bolding, highlighting or any other marking of the text to set it apart from the rest of the document. In one arrangement, when the formatted text is re-read, the highlighted text also exhibits a sound during the highlighting to indicate the highlighting of the text, such as a different tone, a background noise, a tone at the beginning and end of the highlighted text, or any other audible indication.

The system is compatible with controls on ear buds, stylus, smartphones, smart watches, a wireless remote, a voice control device any device using a wireless protocol such as Bluetooth, ZigBee, Z-Wave, Wi-Fi, or any other wireless protocol, or any other electronic device for accepting audio commands. In one embodiment, there is also a proprietary wireless device associated with the system to provide input to the app, such as a remote control, a key fob or the like. In one arrangement, buttons are provided on the remote control or key fob in order to play/pause the text or to move forward or backward among the text, a page, a paragraph or one line at a time. Buttons are also provided for highlighting the preceding page, paragraph or line. Further buttons may be available for starting and stopping highlighting as the text is being read. The remote control or key fob automatically syncs with the computing device, such as a smartphone, through a wireless protocol, such as Bluetooth or a similar network technology, and contains a battery to operate on its own power.

The signal may be provided by a push-button, for example, on the screen of the smartphone or other electronic device, or by a remote control or remote control 100 such as a key fob. Alternatively, a unique word or signal spoken by the reviewer and recognized by the app may be used so that the reviewer may provide signals by hands-free means to the app. An ongoing verbal signal may be used to indicate ongoing highlighting of the document in order to highlight text as passages are being read. The resulting solution makes document review with TTS a hands-off process, simple, and interruption-free.

With reference to FIG. 1, at step 10, a Text-to-Speech (TTS) application or (app) 12 (TTS app 12) having a Text-to-Speech (TTS) engine 14 is downloaded onto, installed onto or run on a computing device 16, such as a laptop, computer, smart phone, tablet, smart watch, a digital voice assistant such as the Amazon Echo, Google Home, Apple Siri Hub, or other digital voice assistant or any other computing device having an TTS app 12 installed thereon. In one arrangement, the TTS engine 14 is a module or portion of software code that reads text 20 and converts it to a spoken or natural voice 22 though a speaker 24 connected, directly or indirectly, to computing device 16.

At step 26 text 20 is downloaded onto the TTS application 12 having TTS engine 14 and the TTS app reads text 20 with a natural voice 22 aloud through speaker 24. At step 28 when the reviewer 30 hears text 20 that he or she wishes to highlight, the reviewer 30 provides a first signal 32 to the TTS app 12 to select the text 20 contemporaneous with when it is spoken, or shortly after it is spoken. First signal 32 may be a predefined verbal signal, such as a voice command such as “highlight” or the like, to benefit from hands-free operation. Or, alternatively, first signal 32 may be a push of a button (110, 115, 120, 125, 130, 135) on a remote control 100. First signal 32 is wirelessly transmitted to computing device 16.

It is to be understood that the functionality of the remote control 100 may be incorporated within the TTS app 12 itself and therefore that the remote control 100 is optional. That is, the buttons (110, 115, 120, 125 130, 135) of remote control 100 may be displayed on a display of the computing device 16, and/or buttons or keys of the computing device 16 may take on the functionality of the buttons (110, 115, 120, 125 130, 135) of remote control 100. In this way, the need for remote control device 100 is eliminated. However, use of the remote control device 100 may increase convenience and ease of use in some arrangements.

According to the instructions stored in memory 34 of computing device 16, the selection of text 20 is highlighted at step 36. The highlighting is registered on the text file 38 within the TTS app 12, and stored in a modified text version 40 of the text file 38 within the TTS app 12. In one arrangement, once the first signal 32 is transmitted to the TTS app 12, a predetermined amount of text 20 is highlighted, such as a predetermined number of sentences before and/or after transmission of the first signal 32, a predetermined amount of words before and/or after transmission of the first signal 32, a predetermined amount of time before and/or after transmission of the first signal 32, or any other amount of text 20. In an alternative arrangement, after the first signal 32 is transmitted, the amount of text 20 that is highlighted is affected by a second signal 42 that is provided by the reviewer 30. This second signal 42 may be a similar or identical signal as the first signal 32 and may be a press of a button (110, 115, 120, 125, 130, 135) on a remote control device 100, a press of a button (110, 115, 120, 125, 130, 135) on a touch screen, a voice command, or any other signal. In one arrangement, once the second signal 42 is transmitted to the TTS app 12, a predetermined amount of text 20 is highlighted, such as a predetermined number of sentences before and/or after transmission of the first signal 32 and second signal 40, a predetermined amount of words before and/or after transmission of the first signal 32 and second signal 42, a predetermined amount of time before and/or after transmission of the first signal 32 and second signal 42, or any other amount of text. A such, the use of a second signal 42 allows the reviewer 30 to have greater amount of control over the amount of text 20 that is highlighted. Alternatively, the second signal 42 indicates when the highlighting is to be stopped and the TTS app 12 highlights the text 20 between the first signal 32 and the second signal 42. This process may be perceived as “On-the-Go Highlighting”.

At step 44, the speech-to-text may be advanced or backtracked by page, paragraph or line either by a reviewer's verbal command or by a push of a button (110, 115, 120, 125, 130, 135) on the remote control 100.

At step 46, the text 20 of the highlighted portions may be read back as a verbal summary or provided to the reviewer 30. This may be accomplished by issuing a third signal 48, such as a press of a button (110, 115, 120, 125, 130, 135) of remote control 100, or a verbal command. Any number of other commands or buttons can be used to control operation of the TTS app 12.

In one arrangement, to represent different text effects, such as highlighting and other forms of emphasis, lower-level background noise is used, which may be heard continually with the voice reading the text 20 to indicate the highlighting. At step 50, a remote control 100 or key fob may synchronize with the computing device 16, such as a smartphone on which the TTS app 12 is running.

At step 54, in one arrangement, as the text 20 is read aloud by TTS app 12, the text 20, and any highlighting or other operations, are displayed simultaneously on a display 52 of computing device 16, such as a smartphone.

At step 56 the TTS app 12 provides controls 58 to move forward or backward by line, paragraph, or page. In one arrangement, controls 58 are displayed on display 52 of computing device 16.

At step 60 the remote control 100 or key fob allows the transmission of a signal (32, 42, 48) by a reviewer 30 to indicate that text 20 is to be highlighted, either by line, paragraph or page, without stopping the reading.

At step 62 the TTS app 12 transmits a report 64 identifying the highlighted portions of text 20, as well as an account of the amount of time that was spent reviewing the text 20 to a digital account, such as an email address 66 or database 68 by recognizing a fifth command 70 to transmit the report 64.

At step 72, the app tracks time spent reviewing and editing the text 20 in document from the opening of the document through to the closing or sending of the document. This ability is extremely useful to report a summary of time spent reviewing and editing a document to a time-tracking application as used by law firms, for example.

With reference to FIG. 2, a remote control 100, for example, a key fob or a smartphone, is presented for use with the TTS app 12, is shown. In one arrangement, the remote control 100 has a housing with a keyring 105 attached thereon for retaining keys or attaching to a lanyard or another component. A split ring style may be used to mount one or more keys thereon. The remote control 100 has a plurality of buttons button (110, 115, 120, 125, 130, 135) thereon, namely, the following types of buttons: (1) a button to highlight the sentence previously read (“line button”) 110 which enables the reviewer 30 to recall and highlight a sentence before the one that was just heard without stopping the reading of the document; (2) a highlight previous paragraph button 115, which enables the reviewer 30 to highlight the paragraph that was just read without stopping the reading of the document; and (3) a page button 120 which highlights the current page in its entirety. On the other side of remote control 100 is a highlight current sentence button 125, a highlight current paragraph button 130 and a play/pause button 135 which controls the playback of the document reading without losing the present position. The housing of remote control 100 contains electronics to transmit the command to the TTS app wirelessly (for example, via Bluetooth or Wi-Fi, however any other wireless protocol is hereby contemplated for use) when pushed by the reviewer 30. In an embodiment, the buttons button (110, 115, 120, 125, 130, 135) are push buttons, and in another embodiment, the buttons may be contact buttons where mere contact of a reviewer's finger transmits the command, such as a touch screen.

The disclosure has been described herein using specific embodiments for the purposes of illustration only. It will be readily apparent to one of ordinary skill in the art, however, that the principles of the disclosure can be embodied in other ways. Therefore, the disclosure should not be regarded as being limited in scope to the specific embodiments disclosed herein, but instead as being fully commensurate in scope with the following claims.

What is claimed:

1. A method of highlighting text in a text-to-speech system, the system comprising the steps of:
providing a text to speech application (TTS app);
installing the TTS app on a computing device;
installing text onto the TTS app;
reading text by the TTS app aloud to a reviewer;
transmitting a first signal to the TTS app by the reviewer while the TTS app is reading the text;
highlighting a portion of the text by the TTS app in response to receiving the first signal by the reviewer simultaneously while continuing to read text.

2. The method of claim 1, wherein the first signal is a button press of a remote control device.

3. The method of claim 1, wherein the first signal is a first voice command.

4. The method of claim 1, wherein the computing device is smartphone.

5. The method of claim 1, further comprising the step of highlighting a predetermined amount of text before the transmission of the first signal.

6. The method of claim 1, further comprising the step of highlighting a predetermined amount of text after the transmission of the first signal.

7. The method of claim 1, further comprising the step of highlighting a predetermined portion of the text in response to the transmission of the first signal, such as highlighting a predetermined number of sentences or paragraphs.

8. The method of claim 1, further comprising the step of transmitting a report of the highlighted text in response to a second signal.

9. The method of claim 1, wherein the text is highlighted without the need to interrupt reading of the text.

10. The method of claim 1, wherein the text is highlighted without the need to rewind reading of the text.

11. The method of claim 1, further comprising the step displaying the text as it is read on a display of the computing device.

12. A method of highlighting text in a text-to-speech system, the system comprising the steps of:
providing a text to speech application (TTS app);
installing the TTS app on a computing device;
installing text onto the TTS app;
reading text by the TTS app aloud to a reviewer;
transmitting a first signal to the TTS app by the reviewer while the TTS app is reading the text;
highlighting a portion of the text by the TTS app in response to receiving the first signal by the reviewer simultaneously while continuing to read text;
wherein the highlighting of the text does not require interrupting the reading of the text or rewinding the reading of the text.

13. The method of claim 12, wherein the first signal is a button press of a remote control device.

14. The method of claim 12, wherein the first signal is a first voice command.

15. The method of claim 12, wherein the computing device is smartphone.

16. The method of claim 12, further comprising the step of highlighting a predetermined amount of text before the transmission of the first signal.

17. The method of claim 12, further comprising the step of highlighting a predetermined amount of text after the transmission of the first signal.

18. The method of claim 1, further comprising the step of highlighting a predetermined portion of the text in response to the transmission of the first signal, such as highlighting a predetermined number of sentences or paragraphs.

19. The method of claim 1, further comprising the step of transmitting a report of the highlighted text in response to a second signal.
